(19) United States
(12) Patent Application Publication
(10) Pub. No.: US 2014/0111050 A1
(43) Pub. Date: Apr. 24, 2014

(54) IPM ROTOR MAGNET SLOT GEOMETRY FOR IMPROVED HEAT TRANSFER

(71) Applicant: REMY TECHNOLOGIES, LLC, Pendleton, IN (US)

(72) Inventor: Bradley D. Chamberlin, Pendleton, IN (US)

(73) Assignee: REMY TECHNOLOGIES, LLC, Pendleton, IN (US)

(21) Appl. No.: 13/659,568

(22) Filed: Oct. 24, 2012

(51) Int. Cl. H02K 9/22; H02K 15/02

(52) U.S. Cl. 310/156.08; 29/598

(57) ABSTRACT

A rotor includes a stack of metal laminations each having a plurality of magnet slots, corresponding magnet slots of the laminations being substantially aligned with one another and thereby forming longitudinal channels in the rotor, selected ones of the magnet slots having at least one feature protruding from at least one long side thereof. The rotor also includes a plurality of magnets each having a pair of long sides in cross-section, each magnet being disposed in a respective one of the longitudinal channels, and includes a thermal conductor connecting at least one of the long sides of one of the magnets with an adjacent long side of a magnet slot having the at least one feature. The feature abuts a long side of a respective one of the magnets at a distance away from the long side of the respective magnet slot.

### BACKGROUND

The present invention relates generally to an interior permanent magnet (IPM) electric rotating machine such as a motor and, more particularly, to an IPM rotor structure that provides improved efficiency.

The use of permanent magnets generally improves performance and efficiency of electric machines. For example, an IPM type machine has magnetic torque and reluctance torque with high torque density, and generally provides constant power output over a wide range of operating conditions. An IPM electric machine generally operates with low torque ripple and low audible noise. The permanent magnets may be placed on the outer perimeter of the machine's rotor (e.g., surface mount) or in an interior portion thereof (i.e., interior permanent magnet, IPM). IPM electric machines may be employed in hybrid or all electric vehicles, for example operating as a generator when the vehicle is braking and as a motor when the vehicle is accelerating. Other applications may employ IPM electrical machines exclusively as motors, for example powering construction and agricultural machinery. An IPM electric machine may be used exclusively as a generator, such as for supplying portable electricity.

Rotor cores of IPM electrical machines are commonly manufactured by stamping and stacking a large number of sheet metal laminations. In one common form, these rotor cores are provided with axially extending slots for receiving permanent magnets. The magnet slots are typically located near the rotor surface facing the stator. Motor efficiency is generally improved by minimizing the distance between the rotor magnets and the stator. Various methods have been used to install permanent magnets in the magnet slots of the rotor. These methods may either leave a void space within the magnet slot after installation of the magnet or completely fill the magnet slot.

One source of heat in IPM electric machines is the permanent magnets within the rotor. One conventional practice includes injection molding a nylon type material into the openings/voids on either lateral end of a permanent magnet. Typically, such openings are specifically designed to help concentrate the magnetic flux in the rotor and thereby optimize performance of the electric machine.

A permanent magnet may be positioned within a magnet slot that contains a pair of edge supports and a pair of opposing faces. Any gap that exists between the sides of the permanent magnets and the respective opposing faces is typically small to improve magnetic performance and to accurately position the permanent magnets. When the rotor is injection molded for securing the permanent magnets in place, the injection mold material does not fill into the gaps due to their small size. As a result, trapped air may create voids and axially extending void spaces. A press-fit permanent magnet that has been molded in place may have only air between its sides (i.e., major planar faces) and the opposing faces of the magnet slot. Trapped air greatly reduces heat transfer from the permanent magnets. In addition, if the electric machine is an oil cooled machine where oil is splashed on the rotor, the oil may collect in any void spaces in the magnet slots of the rotor. The collection of oil in the void spaces of the rotor is undesirable because it can lead to an unbalancing of the rotor.

Conventional IPM rotors are not adequately cooled, resulting in lower machine efficiency and output, and excessive heat may result in demagnetization of permanent magnets and/or mechanical problems.

### SUMMARY

It is therefore desirable to obviate the above-mentioned disadvantages by providing a structure and method for improving a rotor's magnet slot geometry and thereby facilitating the easy flow of thermally conductive material between a permanent magnet and the opposing faces of the magnet slot, while still providing precise magnet positioning. The improved geometry allows the thermally conductive material to displace air and thereby improves heat transfer from the permanent magnet.

According to an exemplary embodiment, a rotor includes a stack of metal laminations each having a plurality of magnet slots, the stacked laminations being substantially aligned with one another so that corresponding aligned magnet slots form longitudinal channels in the rotor, selected ones of the magnet slots having at least one feature protruding from at least one side thereof. The rotor also includes a plurality of magnets each having a side, each magnet being disposed in a respective one of the longitudinal channels, and a thermal conductor connecting the side of one of the magnets with the side of one of the selected magnet slots having at least one protruding feature. The feature abuts and thereby spaces the magnet side from the side of the respective magnet slot.

According to another exemplary embodiment, a method of facilitating heat transfer in a rotor includes forming a plurality of metal laminations each having a plurality of magnet slots, selected ones of the magnet slots having at least one feature protruding from at least one long side thereof, stacking the laminations and thereby aligning the magnet slots to form longitudinal channels in the rotor, placing magnets in the longitudinal channels, the magnets each having at least one long side in cross-section, and providing a thermal conductor contiguously between one of the long magnet slot sides having at least one feature and the long side of the corresponding magnet.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a schematic cross sectional view of an electric machine;

FIG. 2 is a perspective view of an interior permanent magnet (IPM) rotor of an electric machine;

FIG. 3 is a schematic view of a permanent magnet;

FIG. 4 is a top plan view of an interior permanent magnet (IPM) rotor of an electric machine;

FIG. 5 is an enlarged view of a portion of the rotor of FIG. 4, the portion grouped as a set of permanent magnets that may be defined as a magnetic pole;

FIG. 6 is a top plan view of an interior permanent magnet (IPM) rotor of an electric machine;

FIG. 7A-7E show different exemplary embodiments for a magnet slot formed in a lamination of an interior permanent magnet (IPM) rotor;

FIG. 8 is a partial cross-sectional plan view of a lamination stack having a permanent magnet disposed in an axially extending magnet channel of a rotor, according to an exemplary embodiment;

FIG. 9 is a partial cross-sectional plan view of a set of laminations having interlocking features, according to an exemplary embodiment; and

FIG. 10 is a top plan view of magnets disposed in magnet slots formed in a lamination of an IPM rotor.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

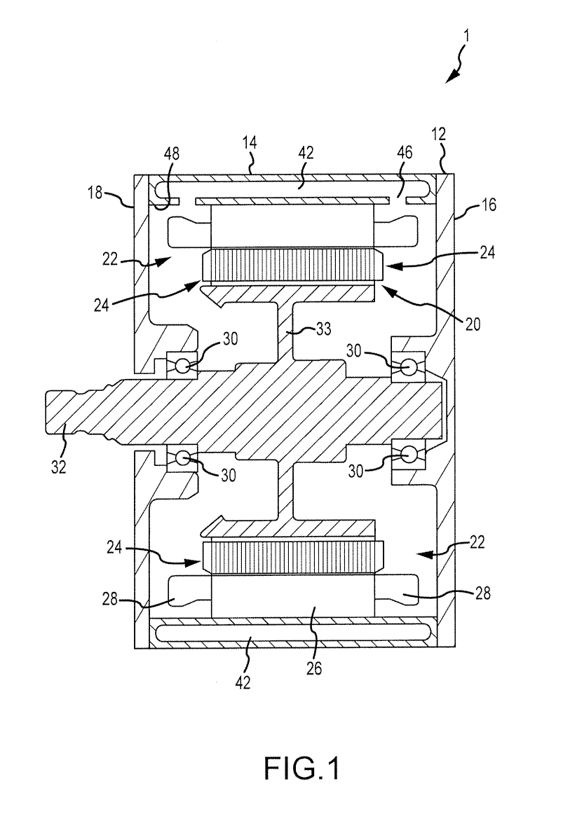

FIG. 1 is a schematic cross sectional view of an exemplary electric machine assembly 1. Electric machine assembly 1 may include a housing 12 that includes a sleeve member 14, a first end cap 16, and a second end cap 18. An electric machine 20 is housed within a machine cavity 22 at least partially defined by sleeve member 14 and end caps 16, 18. Electric machine 20 includes a rotor assembly 24, a stator assembly 26 including stator end turns 28, and bearings 30, and an output shaft 32 secured as part of rotor 24. Rotor 24 rotates within stator 26. Rotor assembly 24 is secured to shaft 32 by a rotor hub 33. In alternative embodiments, electric machine 20 may have a “hub-less” design.

In some embodiments, module housing 12 may include at least one coolant jacket 42, for example including passages within sleeve member 14 and stator 26. In various embodiments, coolant jacket 42 substantially circumscribes portions of stator assembly 26, including stator end turns 28. A suitable coolant may include transmission fluid, ethylene glycol, an ethylene glycol/water mixture, water, oil, motor oil, a gas, a mist, any combination thereof, or another substance. A cooling system may include nozzles (not shown) or the like for directing a coolant onto end turns 28. Module housing 12 may include a plurality of coolant jacket apertures 46 so that coolant jacket 42 is in fluid communication with machine cavity 22. Coolant apertures 46 may be positioned substantially adjacent to stator end turns 28 for the directing of coolant to directly contact and thereby cool end turns 28. For example, coolant jacket apertures 46 may be positioned through portions of an inner wall 48 of sleeve member 14. After exiting coolant jacket apertures 46, the coolant flows through portions of machine cavity 22 for cooling other components. In particular, coolant may be directed or sprayed onto hub 33 for cooling of rotor assembly 24. The coolant can be pressurized when it enters the housing 12. After leaving the housing 12, the coolant can flow toward a heat transfer element (not shown) outside of the housing 12 which can remove the heat energy received by the coolant. The heat transfer element can be a radiator or a similar heat exchanger device capable of removing heat energy.

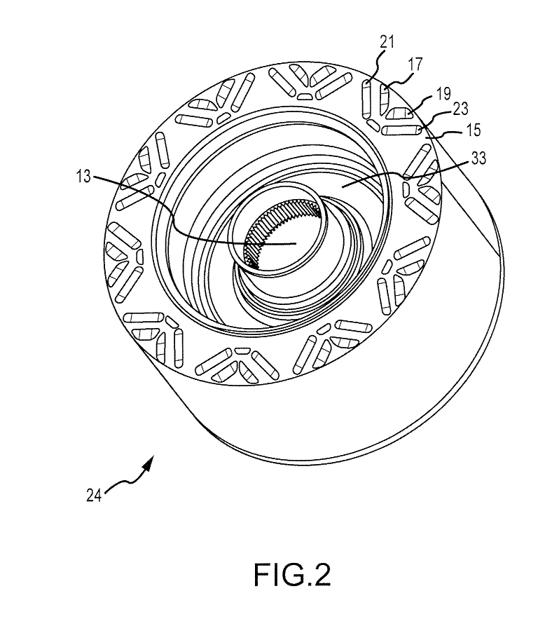

FIG. 2 is a perspective view of an IPM rotor 24 having a hub assembly 33 with a center aperture for securing rotor 24 to shaft 32. Rotor 24 includes a rotor core 15 that may be formed, for example, in a known manner as a stack of individual metal laminations, for example steel or silicon steel. Rotor core 15 includes a plurality of axially-extending magnet slots 17, 19, 21, 23 each having an elongated shape, for example an elongated oval shape. In addition, although variously illustrated herein with sharp corners and ends, magnet slots 17, 19, 21, 23 typically have rounded ends for reducing stress concentrations in the rotor laminations. The example of FIG. 2 has ten sets of magnet slots, where each set includes magnet slots 17, 19, 21, 23, and where the sets define alternating poles (e.g., N-S-N-S, etc.) in a circumferential direction. Any appropriate number of magnet sets may be used for a given application. Magnet slots 17, 19, 21, 23 and corresponding magnets 2 may extend substantially the entire axial length of rotor core 15.

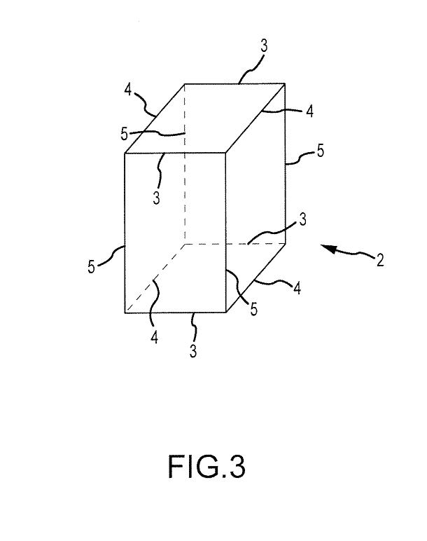

FIG. 3 shows an exemplary permanent magnet 2 formed as a rectangular column with a width defined as the linear dimension of any edge 3, a length defined as the linear dimension of any edge 4, and a height defined as a linear dimension of any edge 5. While a regular rectangular solid is described for ease of discussion, a permanent magnet of the various embodiments may have any appropriate shape. For example, magnets 2 may have rounded ends, sides, and/or corners. Respective areas bounded by edges 3, 4 may herein be referred to as magnet top and bottom. Respective areas bounded by edges 3, 5 may herein be referred to as magnet ends. Respective areas bounded by edges 4, 5 may herein be referred to as magnet lateral sides. Magnets 2 may have any appropriate size for being installed into the various magnet slots 17, 19, 21, 23. Magnets 2 are typically formed of rare-earth materials such as Nd (neodymium) that have a high magnetic flux density. Nd magnets may deteriorate and become demagnetized in the event that operating temperature is too high. When an electric machine is operating under a high temperature condition, the permanent magnets become overheated. For example, when a Nd magnet reaches approximately 320 degrees Celsius, it becomes demagnetized standing alone. When a combination of the temperature and the electric current of the machine becomes large, then demagnetization may also occur. For example, demagnetization may occur at a temperature of one hundred degrees C. and a current of two thousand amperes, or at a temperature of two hundred degrees C. and a current of two hundred amperes. As an electric machine is pushed to achieve greater performance, the increase in machine power consumption and associated power losses in the form of heat tests the stability of the magnets themselves. Therefore, it may be necessary to add Dy (dysprosium) to the magnet compound to increase the magnets' resistance to demagnetization. For example, a neodymium-iron-boron magnet may have up to six percent of the Nd replaced by Dy, thereby increasing coercivity and resilience of magnets 2. Although dysprosium may be utilized for preventing demagnetization of magnets 2, it is expensive, and the substitution of any filler for Nd reduces the nominal magnetic field strength. The Dy substitution may allow an electric machine to run hotter but with less relative magnetic field strength.

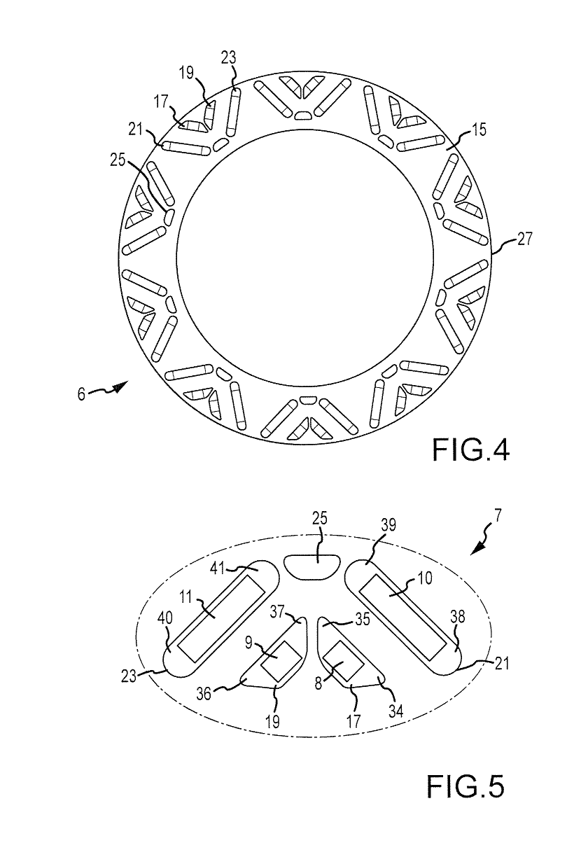

FIG. 4 is a top plan view of a rotor assembly 6 having ten sets of magnet slots 17, 19, 21, 23, and FIG. 5 is an enlarged top view of one magnet set 7 thereof. Although various ones of magnet slots 17, 19, 21, 23 are shown with sharp edges, such edges may be rounded. After a permanent magnet 8 has been placed into magnet slot 17, there are gaps 34, 35 between the magnet 8 ends and the interior wall of slot 17. Similarly, after a permanent magnet 9 has been placed into magnet slot 19, there are gaps 36, 37 between the magnet 9 ends and the interior wall of slot 19. After a permanent magnet 10 has been placed into magnet slot 21, there are gaps 38, 39 between the magnet 10 ends and the interior wall of slot 21. After a permanent magnet 11 has been placed into magnet slot 23, there are gaps 40, 41 between the magnet ends and the interior wall of slot 23. Gaps 34-41 prevent a short-circuiting of magnetic flux when a direction of magnetization of respective ones of magnets is orthogonal to the magnet ends. When the magnet slots are located very close to the rotor exterior to maximize motor efficiency, only a thin bridge of rotor core material formed by the stacked laminations of the rotor separates magnet slots 17, 19, 21, 23 from the exterior surface 27 of the rotor.

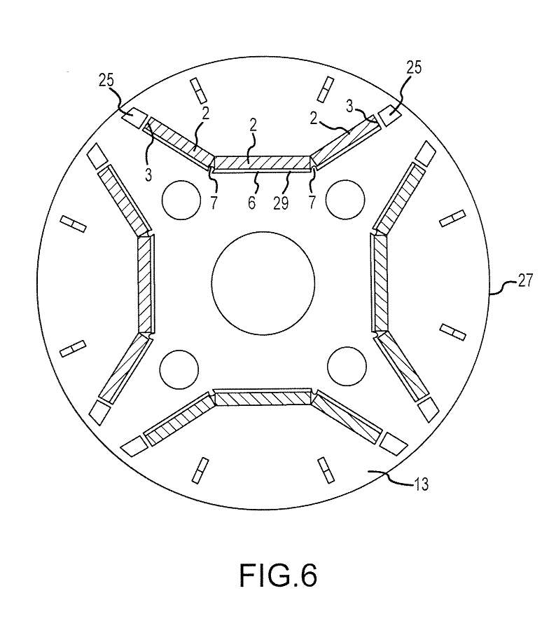

FIG. 6 is a top view of a conventional rotor assembly 27 having a stack of laminations 13 with axially aligned magnet slots 6. Magnet slot 6 has two edge supports 7 that provide lateral support for each of three permanent magnets 2. Magnet edges 3 are laterally supported at ends of magnet slot 6 or by edge supports 7. Cooling holes 25 are provided for axial air flow through rotor assembly 27. There may be a slight gap 29 between one or both long sides of each magnet 2 and the respective adjacent surfaces of corresponding magnet slots 6. The air within gaps 29 may remain after rotor assembly, even when a resin or thermoset is injected because such gaps 29 may be quite small and irregular. In particular, a press-fitting structure having only edge supports 7 may cause chipping or other damage to magnets 2 when the fit is close, and the resin, paste, or thermoset may be too large and/or too high in viscosity to properly fill gaps 29.

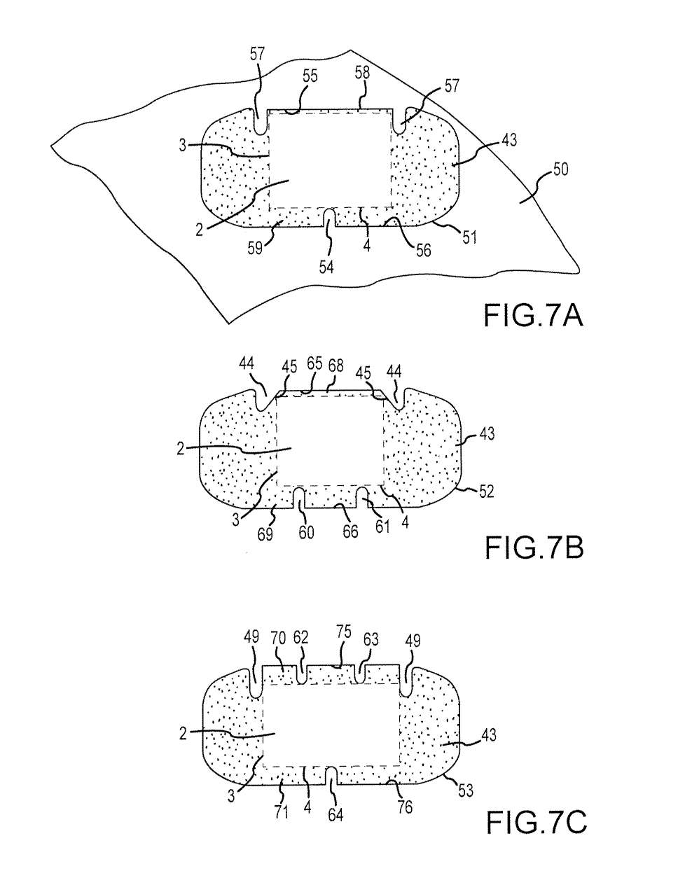

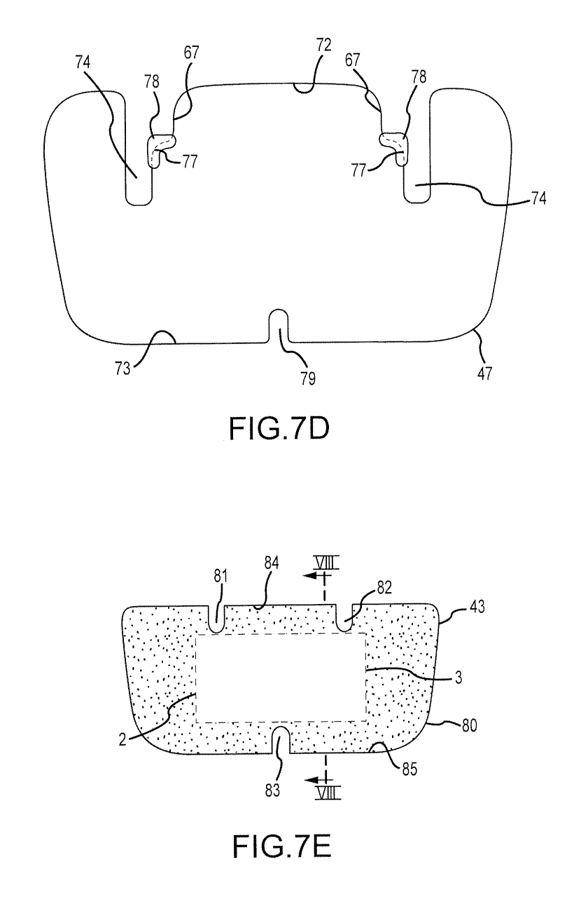

FIG. 7A is a partial view of a lamination 50 having a magnet slot 51 and other similar magnet slots (not shown) formed therein. Lamination 50 is stacked on top of a number of identical or similar laminations to form a lamination stack where magnet slot 51 is aligned with substantially similar or identical magnet slots of the other laminations so that the aligned magnet slots form a longitudinal channel for enclosing permanent magnet 2. Magnet slot 51 is formed to define two edge supports 57 that extend inwardly from wall 55 and prevent movement of magnet 2 in a direction substantially parallel to the cross-sectionally long side 4 of magnet 2. Magnet slot 51 also defines a protruding feature 54 that extends from an opposing wall 56 of magnet slot 51. Magnet 2 is snugly secured between feature 54 and wall 55 to prevent movement in a direction substantially parallel to the cross-sectionally short side 3 of magnet 2. After installation of permanent magnet 2, an encapsulant 43 such as thermally conductive resin or thermoset is injected into the longitudinal channel for securing magnet 2 and for integrating the rotor structure. A slight gap 58 is formed between slot wall 55 and magnet 2. Such gap 58 may contain trapped air that greatly reduces heat transfer, such as for transferring heat from magnet 2 into lamination 50. By contrast, a large gap 59 is formed between slot wall 56 and magnet 2, which allows encapsulant 43 to completely fill the space of gap 59 with thermally conductive material and thereby remove substantially all air. As a result, heat from magnet 2 is transferred more efficiently to lamination 50 via slot wall 56. Although undesirable, the presence of a slight amount of porosity in encapsulant 43 may be acceptable in most applications.

FIG. 7B shows a magnet slot 52 that may be formed in a lamination 50. Magnet slot 52 defines two edge supports 44 that extend inwardly from wall 65 and prevent movement of magnet 2 in a direction substantially parallel to the long side 4 of magnet 2. Edge supports 44 each have a transition surface 45 that may include indentations for reducing the likelihood of damage to edges of magnet 2. Such indentations may also include cushioning material, for example a pair of inserts, for further reducing the possibility of damage to magnet 2. Magnet slot 52 also defines protruding features 60, 61 that extends from an opposing wall 66 of magnet slot 52. Magnet 2 is snugly secured between features 60, 61 and transition surfaces 45 to prevent movement in a direction substantially parallel to the short side 3 of magnet 2. After installation of permanent magnet 2, an encapsulant 43 such as thermally conductive resin or thermoset is injected into the longitudinal channel for securing magnet 2 and for integrating the rotor structure. A gap 68 is formed between transition surfaces 45 and magnet 2. Such gap 68 provides an offset to assure that the space between magnet 2 and slot wall 65 is completely filled with encapsulant. Similarly, one or more gaps 69 are formed between slot wall 66 and magnet 2, which allows encapsulant 43 to completely fill the space of gap(s) 69 with thermally conductive material and thereby remove all air. As a result, heat from magnet 2 is transferred more efficiently to lamination 50 via slot walls 65, 66.

FIG. 7C shows a magnet slot 53 that may be formed in a lamination 50. Magnet slot 53 defines two edge supports 49 that extend inwardly from wall 75 and prevent movement of magnet 2 in a direction substantially parallel to the long side 4 of magnet 2. Magnet slot 53 also defines protruding features 62, 63 that extend from slot wall 75 in the area between edge supports 49. Magnet slot 53 further defines a feature 64 that extends from an opposing wall 76 of magnet slot 53. Magnet 2 is snugly secured between features 62, 63 and feature 64 to prevent movement in a direction substantially parallel to the short side 3 of magnet 2. After installation of permanent magnet 2, an encapsulant 43 such as thermally conductive resin or thermoset is injected into the longitudinal channel for securing magnet 2 and for integrating the rotor structure. One or more gaps 70 are formed between slot wall 75 and magnet 2. Such gap(s) 70 provides an offset to assure that the space between magnet 2 and slot wall 75 is completely filled with encapsulant. Similarly, a gaps 71 is formed between slot wall 76 and magnet 2, which allows encapsulant 43 to completely fill the space of gap 71 with thermally conductive material and thereby remove all air. As a result, heat from magnet 2 is transferred more efficiently to lamination 50 via slot walls 75, 76.

FIG. 7D is a top plan view of a magnet slot 47 that may be formed in lamination 50. Magnet slot 47 defines two edge supports 74 that extend inwardly from wall 72 and prevent movement of a magnet in a direction substantially parallel to the cross-sectional long side of the magnet. Edge supports 74 each have a transition surface 67 that includes one or more indentations 77 for reducing the likelihood of damage to edges of the magnet. Indentation 77 includes an insert 78, for further reducing the possibility of damage to the magnet by providing a cushioning surface for abutting the magnet. Magnet slot 47 also defines a protruding feature 79 extending from a wall 73 of magnet slot 47. A magnet may be snugly secured between feature 79 and inserts 78 to prevent movement in a direction substantially parallel to the cross-sectional short side of the magnet. After installation of the permanent magnet and a thermally conductive encapsulant, respective spaces between slot walls 72, 73 and the magnet are completely filled with the encapsulant. As a result of the offsets provided between slot walls 72, 73 and the magnet, the injection of thermally conductive material removes all air. In operation, heat from the magnet is transferred more efficiently to lamination 50 via slot walls 72, 73.

There is generally a maximum power output that is related to the electromagnetic limit of an electric machine, where this ideal maximum power theoretically exists in a hypothetical case where the electric machine experiences no losses. Such ideal power can be expressed as a maximum power for a short duration of time. In an actual electric machine operating in the real world, there are losses due to heat, friction, decoupling, and others. The maximum continuous power that is produced when the electric machine operates continuously may be increased by removing heat from the electric machine. A buildup of heat limits the ability of the machine to run continuously. By removal of heat from hotspots, such as permanent magnets, the continuous power capacity of the electric machine is increased. Cooling of electric machines, for example, has conventionally included the use of cooling jackets around a stator and nozzles for spraying a coolant on end turns of stator coils. Conventional cooling of rotors has included forming coolant channels in and around the rotor. However, the interface between permanent magnets and laminations in the rotor body should be devoid of any trapped air, which is a poor conductor of heat. By selective placement of features in lamination geometry, the injection of thermally conductive encapsulant pushes air out of such interface.

FIG. 7E is a top plan view of a magnet slot 80 that may be formed in lamination 50. Magnet slot 80 defines protruding features 81, 82 that extend from slot wall 84 and defines a feature 83 that extends from an opposing slot wall 85 of magnet slot 80. Magnet 2 may be snugly secured between features 81, 82 and feature 83 to prevent movement in a direction substantially parallel to the cross-sectional short side 3 of magnet 2. Magnet 2 is also secured in place with encapsulant 43.

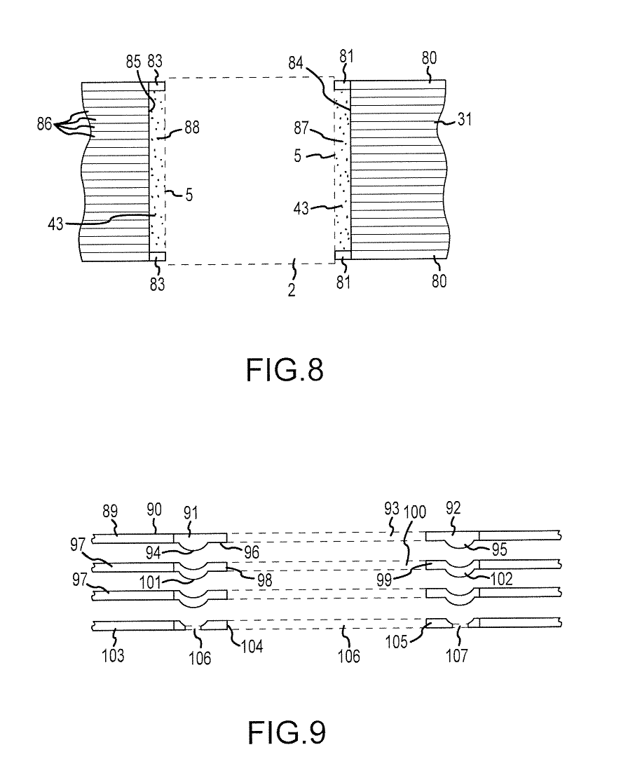

FIG. 8 is a view taken along the line VIII-VIII of FIG. 7E, and shows a lamination stack 31 having lamination 80 placed at a topmost position and a lamination 80 placed at a bottommost position thereof. Intervening laminations 86 are formed without features, but are otherwise identical to lamination 80. Magnet 2 is secured by features 81, 82, 83 (FIG. 7E) of top and bottom laminations 80. In one exemplary embodiment having one hundred laminations, the top twenty laminations of a stack 31 are laminations 80, the next sixty laminations of stack 31 are laminations 86, and the bottom twenty laminations of stack 31 are laminations 80. In such a case, portions of the top and bottom laminations 80 are in direct contact with opposite magnet sides 4, whereas the middle sixty laminations 86 provide more space for encapsulant 43. Respective spaces 87, 88 between longitudinally-extending sides 5 of magnet 2 and magnet slot walls 84, 85 are filled with encapsulant 43. In various embodiments, laminations 86 may be formed to at least partially fill spaces 87, 88 with steel or other lamination material in place of encapsulant 43, thereby improving magnetic performance of the rotor assembly. For example, longitudinal channels of a rotor may extend so that sufficient space is allocated for completely encapsulating magnet 2 in a manner where magnet 2 is also accurately positioned and where magnetic properties of the rotor core are not substantially diminished by a reduction in volume of silicon steel or other lamination material. By increasing the relative amount of lamination steel in a given space 87, 88, the magnetic flux is increased, whereas filling the same space 87, 88 with encapsulant decreases the flux flow but increases heat transfer. Any number of features may be formed in laminations 80 for optimizing both the securement of magnet 2 as well as heat rejection and performance. There may be any number of different geometries for individual magnet slots in lamination stacks of various embodiments. For example, a portion of the magnet slots of a first lamination may have one or more features and the remaining magnet slots of the same first lamination may be formed without any features. In such a case, a different or second lamination of the same stack may have features in its magnet slots that correspond to the magnet slots in the first laminations that are missing features. By selectively implementing features in certain ones of the magnet slots of a rotor assembly, the rotor may be optimized, for example, for a given motor application. In an exemplary embodiment, features may be formed in a subset of laminations of a given magnet channel so that long uninterrupted lengths of thermally conductive encapsulant are avoided when the thermal expansion properties of a filler material might otherwise be problematic. In another example, certain combinations or groupings of permanent magnets may create unwanted harmonics, cogging, or similar problems that may be eliminated by periodically placing one or more features to slightly alter the placement (e.g., pitch) of a magnet and/or to minimize short-circuit leakage flux in a particular region.

The foregoing example may also include the use of segmented magnets. For example, a 100 mm magnet 2 may be replaced by two 50 mm magnets, by four 25 mm magnets, etc. In such a case, eddy currents, and associated heat generation, may be reduced. By increasing the number of magnet segments and making each segment smaller, there is less heat to disperse. Magnets may be segmented axially, radially, circumferentially, and/or tangentially. Segmented magnets may be held by selectively placing features in optimum locations of longitudinal magnet channels, and features may be omitted in locations where a need for increased heat transfer and/or the flow of encapsulant is greater than a need for magnetic performance or the securement of the magnet segment.

FIG. 9 is a partial elevation view of a set of laminations according to an exemplary embodiment. A top lamination 89 has a flat top surface 90. Top lamination 89 has a feature 91 and a feature 92 projecting toward one another from opposite sides of a magnet slot 93. Features 91, 92 respectively have interconnect protrusions 94, 95 that extend as uniform shapes from a bottom side 96 thereof. Adjacent lamination 97 includes features 98, 99 projecting toward one another from opposite sides of a magnet slot 100. Features 98, 99 respectively include interconnect protrusions 101, 102 extending as the same uniform shapes. Interconnect protrusions 101, 102 are formed with a recess on a top side of respective features 101, 102, so that when laminations 97 are stacked on top of one another, protrusions engage recessed portions for aligning and interlocking laminations 97. A bottom lamination 103 includes features 104, 105 projecting toward one another from opposite sides of a magnet slot 106. Features 104, 105 are respectively formed with holes each having a contour with the same shape as interconnect protrusions 94, 95, 101, 102. As a result, the projecting portions of protrusions 101, 102 may be placed into respective holes 106, 107 for aligning and interlocking lamination 97 with lamination 103. The various features provide magnet slot geometry that interlocks and registers laminations and their magnet slots to form a lamination stack with structural integrity, and that precisely aligns magnets while allowing thermally conductive material to easily flow between the magnet and the adjacent surfaces of the lamination stack.

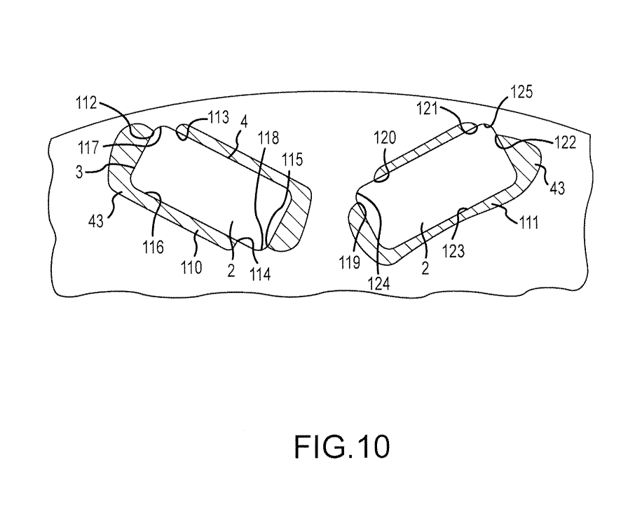

FIG. 10 is a schematic top view of magnets 2 respectively disposed in magnet slots 110, 111 that may be formed in lamination 50. Magnet slot 110 defines protruding features 112-115 that extend from the periphery 116 of slot 110. A notch feature 117 is defined between protruding features 112, 113 and a notch feature 118 is defined between protruding features 114, 115. Diagonal notch features 117, 118 are shaped to secure corresponding corners of magnet 2. Similarly, magnet slot 111 defines protruding features 119-122 that extend from the periphery 123 of slot 111. A notch feature 124 is defined between protruding features 119, 120 and a notch feature 125 is defined between protruding features 121, 122. Notch features 124, 125 secure magnet 2 and prevent lateral movement while offsetting magnet 2 for placement of encapsulant 43. The magnet slot spaces that surround magnets 2 in slots 110, 11 are filled with encapsulant 43 as described hereinabove. In addition, the molding pressure for injecting thermally conductive material 43 may be sufficient to bias a corresponding magnet 2 to the desired nominal magnet position within a magnet slot, for example set against notches 124, 125, based on the injection points of the encapsulant 43. Peripheral surfaces 116, 123 may have protruding or notch type features that abut and thereby space the respective magnets 2 from the peripheral side of the respective magnet slot 110, 111.

In an exemplary embodiment, thermally conductive material 43 may include a nylon material ZYTEL (registered Trademark of E.I. du Pont de Nemours and Co.), in combination with various other substances, that may be injected into gaps 33-41, 68-71, 87-88 in a process that prevents air from becoming entrapped therein. In another exemplary embodiment, a resin material known as LNP Konduit compound (KONDUIT is a registered trademark of SABIC Innovative Plastics) of a type PTF-2BXX may be used. In a further exemplary embodiment, an LNP Konduit compound PTF-1211 may be used. As used herein thermally conductive material may have a thermal conductivity of 0.1 W/(m·K) or greater. The space 25 (e.g., FIGS. 4-5) may optionally be utilized for guiding the flux about permanent magnets 8-11 within a magnet set 7. For example, steel and/or resin may be selectively placed into or floated within space 25. In various embodiments, thermally conductive material 43 having a thermal conductivity of greater than 0.3 W/(m·K) was found to significantly increase output power. In other embodiments, a resin having thermal conductivity of greater than approximately 0.5 to 0.6 W/(m·K) was found to further increase output power while still providing acceptable structural performance. Other embodiments may have a resin with thermal conductivity of 1.4 W/(m·K), and a resin for some applications may be formed with thermal conductivity of 3.0 to 4.0 or greater, depending on the machine operating conditions related to temperature and current. For example, resin material may be created to have a desirable thermal conductivity but such may not be suitable for durability, electrical properties, structural integrity, high temperature stability, thermal expansion properties over a wide temperature range, cost, and other reasons. Thermally conductive plastics used for encapsulating permanent magnets may include polypropylene (PP), acrylonitrile butadiene styrene (ABS), polycarbonate (PC), nylon (PA), liquid-crystal polymers (LCP), polyphenylene sulfide (PPS), and polyetheretherketone (PEEK) as basic resins that are compounded with nonmetallic, thermally conductive reinforcements that dramatically increase thermal conductivities while having minimal effect on the base polymer's manufacturing process. Such thermally conductive polymers have conductivities that may range from 1 to 20 W/(m·K). Thermally conductive polymers generally have higher flexural and tensile stiffness, and lower impact strength compared with conventional plastics, and can be electrically conductive or non-conductive. In an exemplary embodiment a boron nitrate having a high thermal conductivity may be formed in a ceramic binder, whereby a thermal conductivity of the ceramic mixture may be as high as one hundred twenty-five W/(m·K) or more. By comparison, the thermal conductivity of air is approximately 0.02 W/(m·K) at zero degrees C.

There may be a tradeoff between the sizes of gaps and rotor performance objectives. For example, gaps in magnet slots are typically made small to improve magnetic performance and to assure accurate positioning of a magnet therein, but such small space may trap air and/or it may include portions too small for particles to flow therethrough. Specifically, thermally conductive material 43 may include alumina or other additives for increasing thermal conductivity, and such additives may have a size greater than 6-7 microns. It is desirable for thermally conductive material 43 containing relatively large particles to completely fill gaps between permanent magnets and all adjoining exposed surfaces of magnet slots. By implementing the disclosed embodiments, thermally conductive material may easily flow between a magnet and the opposing face(s) of a magnet slot, thereby improving heat transfer. In addition, when the thermally conductivity of material 43 is very high, then less of such material 43 is required to satisfactorily extract the heat of corresponding magnets 2. In such a case, the presence of some trapped air may be acceptable. For example, the use of very highly thermally conductive material 43 may minimize any design tradeoffs between the needs for maximizing magnetic flux and heat transfer.

The disclosed features may be incorporated directly into a slot geometry stamping tool and stamped into a given lamination, in a low cost manufacture that does not require special shapes and tooling. The exact dimensions for a given magnet slot and associated feature(s) should also be based on an analysis of the magnetic route for magnetic flux. For example, irregularities in magnetic routes may be minimized by forming features in positions that avoid unwanted deflections of magnetic flux, such as by forming features with shapes substantially aligned with the direction of magnetic flux and/or in relation to a radius of the rotor. Accordingly, features may be asymmetrical and may have differing individual shapes. Placement of permanent magnets 2 typically is based on consideration of spacing between adjacent magnets, relations of radially inner and radially outer magnet edges within magnet sets, geometry of gaps, magnetic properties of gap-filling materials, and use of any ancillary structure such as magnet wedges or shunts. For example, spacing of magnets may be determined based on radial distance between inner and outer radial edges of specific magnets of a set, on the arrangements of facing edges of adjacent ones of the magnets, on relative permeability, and on other factors. Magnetic permeability of features and thermally conductive filler materials will be much higher than air, but may be lower than the permeability of steel laminations. Since any changes in magnetic permeability of the magnetic circuit may result in production of frequency dependent eddy currents and hysteresis losses, the magnet slot geometry and thermally conductive materials are chosen for minimizing inconsistencies in the magnetic circuit at a high operating speed. By minimizing short-circuit leakage flux while improving inductance for all torque levels, high speed power and efficiency of an electric machine 1 are thereby improved.

Permanent magnets may be magnetized after the rotor assembly has been completed. In addition, a high pressure may be utilized when injecting the resin. Tight tolerances for molds contain the pressure and assure that thin portions of the laminations of rotor body 15 are not thereby deformed. Elevated pressure allows air bubbles and other voids to be removed, whereby thermal conductivity is not compromised.

In an exemplary embodiment, a thermally conductive compound may be a liquid (e.g., melt) at least when it is injected into magnet slots of a rotor assembly. For a thermally conductive ceramic, dynamic compaction may be used. For example, after permanent magnets 8-11 are positioned into magnet slots 17, 19, 21, 23 for each magnet set 7 of rotor assembly 24, rotor body 15 is placed onto a vibration table, a powdered mixture of thermally conductive ceramic material is poured into magnet slots 17, 19, 21, 23, and the powder becomes compacted by vibration and/or force. Such a powder may contain thermally conductive polymers, and may contain alumina, boron nitride, or other suitable thermally conductive filler. A percentage of polymers may be small or zero, depending on a chosen binder material or other processing technique. For example, gaps 34-41, 68-71, 88-89 between magnets 8-11 and rotor body 15 may be used as channels for receiving injected thermally conductive powder. A tamping rod or press bar may be placed at least partly into such gaps for assuring that the powder flows into empty space and becomes compacted. Processes, dies, and materials known to those skilled in pressed powder products may be employed. Such may include, but are not limited to, use of a binder for impregnating the packed powder, vacuum, and others. For example, resin may be placed into the powder before a heat process that melts the mixture, or the powder may be melted into rotor body 15 before adding a binder. Since permanent magnets are typically magnetized after rotor assembly, a heat of up to five-hundred degrees C. may be used for encapsulating permanent magnets with thermally conductive powder. Any appropriate process may be utilized, for example potting, encapsulation, and/or molding according to methods known to those of ordinary skill in the art. For example, a use of thermally conductive powders may include coating the flakes or particles.

Magnetization of permanent magnets 8-11 for each magnet set 7 may be performed by magnetizing all rotor poles (i.e., magnet sets 7) simultaneously or individually after rotor assembly, or rotor poles may alternatively be magnetized prior to encapsulation.

In operation, heat of permanent magnets 8-11 is transferred by the thermally conductive resin, ceramic, or other compound into the lamination stack of rotor body 15. Permanent magnets 8-11 and the lamination stack of rotor body 15 both act as thermal conductors. When a hub 33 is part of rotor assembly 24, such hub 33 conducts the heat of the lamination stack. Oil or other coolant may be in fluid communication with hub 33, and a heat exchanger (not shown) such as an external oil cooler, or hub 33 may be in fluid communication with coolant of cooling jacket 42 (e.g., FIG. 1) for removing heat from the oil.

The distribution of features within a rotor body 15 may be a tool for optimizing the distribution of heat transfer from individual longitudinal channels or from magnet sets 7 and their corresponding longitudinal channels. For example, a rotor may be designed for effecting a columnar transfer function in a longitudinal direction of a single magnet channel or for effecting a columnar transfer function in a longitudinal direction of a magnet set 7. An exemplary transfer function allows for adjusting an amount and respective locations of a plurality of the features within the longitudinal channels to correspondingly adjust a ratio of an amount of surface area of lamination metal contacting the magnets to an amount of surface area of the thermal conductor contacting the magnets. Another exemplary transfer function allows for adjusting an amount and respective locations of a plurality of the features within the longitudinal channels to correspondingly adjust a distribution of steel within the rotor core based on a distribution of heat from the magnets. In one exemplary embodiment, heat may be distributed radially inward from the magnets to a center portion of the rotor, and a hub at the center portion may contain coolant passages or another heat exchanger. Depending on the thermal coefficient of the thermally conductive material being distributed according to the placement and sizes of the features, the distribution of heat may be based on a ratio of a volume of the thermal conductor to a volume of steel for a set of the magnet slots. Other exemplary columnar transfer functions for specifying the construction of longitudinal magnet channels of a rotor body 15 may be implemented by defining feature quadrature orientation and associated feature volumes and feature radial lengths as a function of the aggregate magnetic permeability for the longitudinal extension of a magnet set 7.

Various molding and potting processes may be employed for a given application. For example, a thermal paste or a thermal grease may be installed in areas of particular interest for maximizing heat transfer according to coolant flow. Materials such as nylon resins designed for toughness, structural integrity in high temperature, coefficient of linear thermal expansion, dielectric constant, chemical resistance, etc. are structurally well-suited for encapsulating or otherwise containing permanent magnets of a rotor.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A rotor, comprising:
a stack of metal laminations each having a plurality of magnet slots, the stacked laminations being substantially aligned with one another so that corresponding aligned magnet slots form longitudinal channels in the rotor, selected ones of the magnet slots having at least one feature protruding from at least one side thereof;
a plurality of magnets each having a side, each magnet being disposed in a respective one of the longitudinal channels; and
a thermal conductor connecting the side of one of the magnets with the side of one of the selected magnet slots having at least one protruding feature;
wherein the feature abuts and thereby spaces the magnet side from the side of the respective magnet slot.

2. The rotor of claim 1, wherein the metal laminations comprise a plurality of first and second laminations, and wherein a portion of the magnet slots each have the at least one feature in the first laminations and another portion of the magnet slots have the at least one feature in the second laminations.

3. The rotor of claim 1, wherein the selected ones of the magnet slots each have two long sides each having at least one feature protruding therefrom for abutting respective sides of the magnet.

4. The rotor of claim 3, wherein at least two of the laminations have a plurality of magnet slots that each include a pair of edge support projections along one of the long sides of the respective magnet slot, the edge support projections being structured for preventing lateral movement of a respective one of the magnets.

5. The rotor of claim 4, further comprising an insert placed between the edge support projections and the magnet.

6. The rotor of claim 1, wherein features of adjacent laminations of the stack interlock with one another.

7. The rotor of claim 1, wherein the thermal conductor substantially completely encapsulates the magnets within the respective longitudinal channels.

8. The rotor of claim 1, wherein each magnet slot has first and second sides in proximity to a magnet space, has a pair of edge support projections along the first side defining a lateral space, and has a protruding feature on the second side defining a first width between the first side and the protruding feature.

9. The rotor of claim 8, further comprising a protruding feature on the first side between the pair of edge support projections.

10. The rotor of claim 8, wherein the edge support projections are stepped, wherein space between the first width and the second side defines a second width.

11. The rotor of claim 10, further comprising at least one insert and a magnet, wherein the at least one insert is disposed between the magnet and at least one of the edge support projections.

12. A method of facilitating heat transfer in a rotor, comprising:
forming a plurality of metal laminations each having a plurality of magnet slots, selected ones of the magnet slots having at least one feature protruding from at least one long side thereof;
stacking the laminations and thereby aligning the magnet slots to form longitudinal channels in the rotor;
placing magnets in the longitudinal channels, the magnets each having at least one long side in cross-section; and
providing a thermal conductor contiguously between one of the long magnet slot sides having at least one feature and the long side of the corresponding magnet.

13. The method of claim 12, wherein the placing of at least one of the magnets includes placing at least two features into abutment with the long side of the one magnet.

14. The method of claim 13, wherein the two features are axially displaced from one another.

15. The method of claim 13, wherein the two features are within the same magnet slot of one of the laminations.

16. The method of claim 15, wherein the placing of the thermal conductor includes flowing the thermal conductor to substantially completely encapsulate the magnet within the respective longitudinal channel.

17. The method of claim 13, further comprising adjusting an amount and respective locations of a plurality of the features within the longitudinal channels to correspondingly adjust a ratio of an amount of surface area of lamination metal contacting the magnets to an amount of surface area of the thermal conductor contacting the magnets.

18. The method of claim 12, further comprising adjusting an amount and respective locations of a plurality of the features within the longitudinal channels to correspondingly adjust a distribution of steel within the rotor core based on a distribution of heat from the magnets.

19. A rotor, comprising:
a stack of metal laminations each having a plurality of magnet slots, the stacked laminations being substantially aligned with one another so that corresponding aligned magnet slots form longitudinal channels in the rotor, selected ones of the magnet slots having at least one feature in the periphery thereof;
a plurality of magnets each having a side, each magnet being disposed in a respective one of the longitudinal channels; and
a thermal conductor connecting the side of one of the magnets with the peripheral surface of one of the selected magnet slots having at least one protruding feature;
wherein the feature abuts and thereby spaces the magnet side from the peripheral side of the respective magnet slot.

20. The rotor of claim 19, wherein the feature is a notch.
